(19) United States
(12) Patent Application Publication
(10) Pub. No.: US 2026/0124097 A1
(43) Pub. Date: May 7, 2026

(54) DEVICE AND METHOD FOR FOOT MASSAGE

(71) Applicant: MILLET INNOVATION, Loriol sur Drôme (FR)

(72) Inventors: Hugo LAURENT, Puy-Saint-Martin (FR); Clément ANKAOUA, Grenoble (FR); Maria-Luisa LE BELLER, Étoile-sur-Rhône (FR)

(21) Appl. No.: 19/117,371

(22) PCT Filed: Sep. 29, 2023
(86) PCT No.: PCT/FR2023/051514

§ 371 Date: Mar. 31, 2025

(30) Foreign Application Priority Data
Oct. 1, 2022 (FR) FR2210058

(51) Int. Cl. A61H 7/00; A43B 7/143; A43D 39/00

(52) U.S. Cl. CPC A61H 7/001; A43B 7/143; A43D 39/00; A61H 2201/1253; A61H 2201/164; A61H 2201/165; A61H 2201/1695; A61H 2205/125; A61H 2209/00

(57) ABSTRACT

A foot massage device is designed to be positioned under all or part of the foot and at least under the arch of the foot. The front face of the device comprises a plurality of non-hollow protuberances intended to come into contact with the arch of the foot to exert pressure capable of improving venous return, each protuberance having a base, a top, a height and a shape determining the volume occupied by the protuberance. The protuberances are made of a soft incompressible or moderately compressible material having a Poisson's coefficient greater than 0.30, and are shaped and arranged so that a flattening of the protuberances causes them to spread out, filling all or part of the volume between each of them and significantly increasing the surface area of the device in contact with the foot.

### CROSS-REFERENCE TO RELATED APPLICATIONS

This application is a 371 National Stage of International Application No. PCT/FR2023/051514, filed Sep. 29, 2023, which claims priority to French Patent Application No. FR2210058, filed Oct. 1, 2022, the disclosures of which are herein incorporated by reference in their entirety.

### TECHNICAL FIELD

The present disclosure relates to a foot massage device designed to be positioned under all or part of the foot and at least under the arch of the foot, and a method of massaging the foot using such a device.

### BACKGROUND

It is known to produce insoles having means for exerting a massage movement on a region of the foot, helping or facilitating the functioning of the plantar pump.

An orthopedic insole is known, in particular through U.S. Pat. No. 7,380,352 or EP0971606, that comprises a plurality of cushion-type layers, provided on the insole surface, and including a first cushion-type layer in a forefoot joint area, a second cushion-type layer in a transition zone between the metatarsus and the tarsus, and a third cushion-type layer in the mid-foot transition zone.

A shoe is also known, through CA 2827485 or WO 2012/110763, comprising an upper, a blood flow stimulating element and a sole element, the sole element embedding a fluid pump, a fluid reservoir usable to receive fluid at a high pressure from the pump via a first valve and a second valve usable to activate the blood flow stimulating element under the control of a processor.

Sandals or insoles with protrusions available commercially under various brands are also known, having a presumed foot massage function. In particular, WO2019209642A1 describes a massage insole comprising protuberances whose flexion causes a foot massage effect. This document teaches modulating the flexibility and shape-height and width—of the protuberances to promote their flexion and thus maximize the massage effect.

Documents US20070234593A1, GB2303780A and US20190142107A1 further describe insoles provided with protuberances or hollow projections providing a presumed massage effect and at the very least comfort.

It would be desirable to provide a foot massage device to be placed under the foot, which offers better performance than known devices with respect to stimulating the plantar pump.

### SUMMARY

Embodiments concern a foot massage device, designed to be positioned under all or part of the foot and at least under the arch of the foot, and comprising a front face designed to be in contact with the foot, wherein the front face of the device comprises a plurality of non-hollow protuberances intended to come into contact with the arch of the foot to exert pressure capable of improving venous return, each protuberance having a base, a top, a height and a shape determining the volume occupied by the protuberance. The protuberances are made of a soft incompressible or moderately compressible material having a Poisson's coefficient greater than 0.30, and are shaped and arranged so that a flattening of the protuberances causes them to spread out, filling all or part of the volume between each of them and significantly increasing the surface area of the device in contact with the foot.

According to an embodiment, at least in one region of the device, the protuberances are shaped and arranged so that a 50% reduction in their height causes them to spread out, filling the volume between each of them in a proportion of at least 60%.

According to an embodiment, at least in the arch region of the device, the protuberances are shaped and arranged so that a 50% reduction in their height causes them to spread out, filling the volume between each of them in a proportion of at least 90%.

According to an embodiment, the protuberances are made of a material having a Shore A hardness between 5 and 40 measured in accordance with ISO 48-4.

According to an embodiment, the protuberances have an increasing height as they approach the maximum arch area of the foot.

According to one embodiment, the protuberances have, between their base and their top, a constant or variable height comprised between 1.5 mm and 25 mm.

According to an embodiment, the device is designed to also cover the heel and the sole of the foot and includes protuberances at least in a region of the forefoot corresponding to the metatarsophalangeal line, and at least around the perimeter of the heel.

According to an embodiment, the protuberances are substantially hemispherical in shape and have a height comprised between 0.25 times and 2.5 times the width of their base.

According to an embodiment, at least in the arch region of the device the spacing between two protuberances is comprised between 0.1 times and 0.5 times the width of the protuberances or the average value of their respective widths if they are not identical.

According to an embodiment, the protuberances are made of an elastomer material.

According to an embodiment, the protuberances are made of a material selected from the group comprising Styrene Ethylene Butylene Styrene, a silicone gel, notably PolyDimethylSiloxane, a Polyurethane foam, an Ethylene-Vinyl Acetate foam, Polyvinyl chloride and EPDM rubber.

According to an embodiment, the device comprises a base designed to support at least the heel and the arch of the foot, and a soft layer assembled on the rigid base and in which the protuberances are formed.

According to an embodiment, the base is thermoformable at a temperature comprised between 60° and 80° C.

According to an embodiment, the base is made of a material included in the group comprising Poly Cyclohexylenedimethylene Terephthalate Glycol, Polyethylene Terephthalate Glycol, Polycaprolactone, polylactide type polyester, ethylene-vinyl acetate, Polyurethane, polyethylene, polypropylene and a thermoformable resin.

Embodiments also concern a method of manufacturing and shaping a device as described above, comprising an initial step of manufacturing the device at the end of which the base has a determined shape, and a step of thermoforming the base to adapt its arch region to the shape of a user's foot, the thermoforming step comprising the steps consisting of bringing the device to a thermoforming temperature, for example by immersion in boiling water, applying the device against the foot while it is still hot and is still in a range of thermoforming temperatures, and exerting pressure under the device, in the arch region, to thermoform the device to the shape of the arch of the foot.

Embodiments also concern a method of manufacturing a device as described above, by two-material injection in a mold comprising a first impression designed to receive by injection a material forming the base of the device, and a second impression receiving, after injection of the base, a material forming the soft layer.

Embodiments also concern a method of foot massage for non-therapeutic purposes, using a device designed to be positioned under all or part of the foot and at least under the arch of the foot, the device comprising a front face designed to be in contact with the foot, the method comprising providing, on the front face of the device, a plurality of non-hollow protuberances intended to come into contact with the arch of the foot to exert pressure capable of improving venous return, each protuberance having a base, a top, a height and a shape determining the volume occupied by the protuberance, the protuberances being made of a soft incompressible or moderately compressible material having a Poisson's coefficient greater than 0.30, and being shaped and arranged so that their flattening causes them to spread out, filling all or part of the volume between each of them and significantly increasing the surface area of the device in contact with the foot, the method comprising a first phase of blood ejection by localized pressure of each protuberance on the area of the foot facing it, and a second phase of blood ejection after deformation of the protuberances under the effect of the pressure exerted by the foot, the compressed protuberances together forming an increased surface that exerts a venous return pressure on areas of the foot not solicited during the first phase of blood ejection.

According to an embodiment, the method comprises providing, at least in one region of the device, protuberances shaped and arranged so that a 50% reduction in their height causes them to spread out, filling the volume between each of them in a proportion of at least 60%.

According to an embodiment, the method comprises providing at least in the arch region of the device, protuberances shaped and arranged so that a 50% reduction in their height causes them to spread out, filling the volume between each of them in a proportion of at least 90%.

According to an embodiment, the protuberances are made of a material having a Shore A hardness comprised between 5 and 40 measured in accordance with ISO 48-4.

According to an embodiment, the protuberances are given an increasing height as they approach the maximum arch area of the foot.

According to an embodiment, the protuberances are given, between their base and their top, a constant or variable height comprised between 1.5 mm and 25 mm.

According to an embodiment, the device is designed to also cover the heel and the sole of the foot, the method also comprising providing protuberances at least in a region of the forefoot corresponding to the metatarsophalangeal line, and at least around the perimeter of the heel.

According to an embodiment, the protuberances are given a substantially hemispherical shape and a height comprised between 0.25 times and 2.5 times the width of their base.

According to an embodiment, between two protuberances, at least in the arch region of the device, a spacing is provided comprised between 0.1 times and 0.5 times the width of the protuberances or the average value of their respective widths if they are not identical.

According to an embodiment, the protuberances are realized in an elastomer material.

### BRIEF DESCRIPTION OF THE DRAWINGS

Examples of embodiments of a massage device and method will be described in the following in a non-limiting manner in relation to the attached figures, among which:

FIG. 1 is a partial cross-sectional view of an exemplary embodiment of the device,

FIG. 2 shows the device of FIG. 1 facing a part of the foot,

FIG. 3 shows a first phase of foot compression on the device of FIG. 1,

FIG. 4 shows a second phase of foot compression on the device of FIG. 1,

FIG. 5 and FIG. 6 illustrate a method of calculating the dimensioning of the device of FIG. 1,

FIG. 7 shows an exemplary embodiment of the device of FIG. 1,

FIG. 8 shows an exemplary application of the device of FIG. 1 in the production of an insole,

FIG. 9 shows the insole of FIG. 8 in a right profile view,

FIG. 10 shows the insole of FIG. 8 in a left profile view,

FIG. 11 shows another exemplary application of the device of FIG. 1, and

FIG. 12 illustrates a manufacturing process for the insole of FIG. 8.

### DETAILED DESCRIPTION

The plantar pump ensures the reflux toward the heart of the blood contained in the venous sole, by crushing the soft tissues of the foot when the body weight is applied to the foot. From an anatomical point of view, the foot can indeed be seen as a “reservoir” for the blood network, located at the extremity of the lower limbs, as it is traversed by a particularly developed superficial and deep venous network, mainly at the level of the plantar sole, commonly called the “venous sole”. The two mechanisms of plantar pump and muscular pump act in coordination with phases of foot rolling, and the initiation of venous return from the lower limbs is performed by the activation of the plantar pump when the foot comes into contact with the ground and supports the weight of the body. The crushing of the soft tissues of the plantar sole expels blood from the venous sole toward the upper part of the foot and leg. This initiation occurs from the step attack phase until the lift-off phase of the contralateral foot. The foot muscular pump then takes over and is directly followed by the calf muscular pump. The contraction of the muscles necessary for stabilizing the foot, then of the muscles necessary for propelling the body forward, notably the foot muscles and calf muscles, causes a compression of the veins traversing these muscles. This action allows blood to be expelled from the foot toward the calf and then toward the upper parts of the leg. This phenomenon takes place from the middle of a simple support phase until the foot lifts off. During a so-called oscillating phase, the venous sole refills with blood due to the action of gravity and the centrifugal force generated by the leg movement.

It is known that massaging the plantar sole helps limit venous stasis by effectively compressing the veins to circulate blood. Nevertheless, a massage cannot be administered to a person while they go about their daily activities, and requires the intervention of another person. A massage device is proposed here, designed to exert localized pressure movements at several points of the plantar sole followed by movements of the pressure points, as is done during a manual massage, in order to expel blood from the soft tissues more effectively than known devices. Such a device is essentially intended to be arranged under the arch of the foot, but can also be used to act on other areas of the foot.

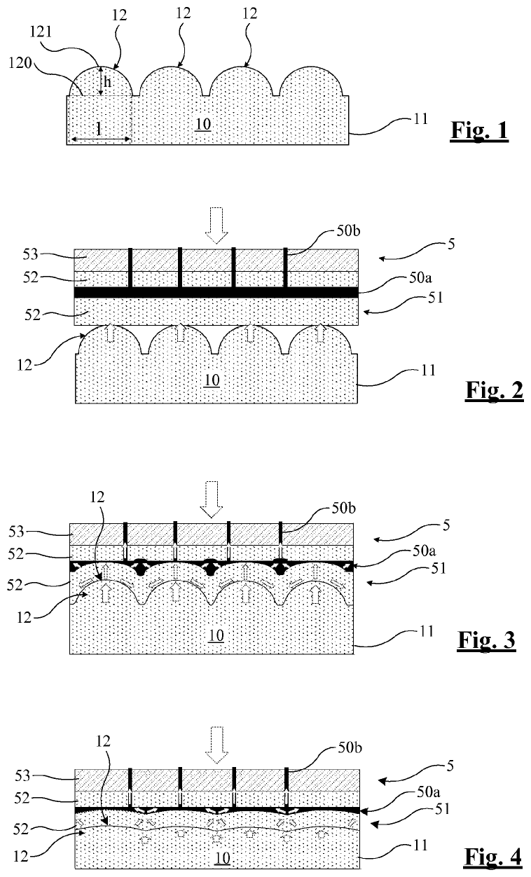

An example of such a device 10 is illustrated in FIG. 1 by a partial cross-sectional view. The device 10 is designed to be positioned under all or part of the foot and at least under the arch of the foot. It comprises a layer 11 of a soft and incompressible or moderately compressible material, whose front face comprises a plurality of protuberances 12 intended to come into contact with the plantar sole to exert pressure capable of improving venous return. Each protuberance 12 has a base 120 (materialized by a dotted line), a top 121, a height h and a shape, here hemispherical, which determines the volume occupied by the protuberance for a given height h thereof.

The protuberances 12 have, between their base and their top, a constant or variable height h, preferably comprised between 1.5 mm and 5 mm, but which, in certain embodiments, may reach 25 mm. In the embodiment represented, the protuberances 12 are of the same height. Due to the flexibility of the material forming the layer 11, the protuberances 12 are perceived as “soft” when pressed with a finger. They are shaped and arranged in such a way that their flattening under the action of the foot causes them to spread out, filling all or part of the empty volume between each of them and significantly increasing the surface area of the device 10 in contact with the foot. More particularly, the function of the protuberances 12 is to use the user's weight to perform an action similar to a massage of the plantar sole, as will be better understood by referring to FIGS. 2 to 4.

FIG. 2 shows the device 10 at a moment when the foot 5 does not yet exert pressure on the protuberances 12. FIG. 3 shows the device 10 at a moment when the foot 5 begins to compress the protuberances 12 and FIG. 4 shows the device 10 at a moment when the foot 5 exerts a maximum compression force on the protuberances 12. In these figures, the reference 52 designates the soft tissues of the plantar sole 51 and the reference 53 designates the bone structure of the foot 5, which is covered by the soft tissues 52. The venous sole 50 is schematized by a horizontal vein 50a extending in the soft tissues 52, and by a set of vertical veins 50b going up toward the heart.

The protuberances 12 operate to locally compress the soft tissues 52 of the plantar sole, quite deeply in a first phase, as would be done during a massage by pressing a finger on an area to be massaged. In a second phase, their low hardness, which is preferably adapted to the hardness of the soft tissues, causes them to flatten and spread out under the prolonged action of the body weight and to “expel” from the soft tissues the blood located between the protuberances 12, as would be done during a massage by moving the finger.

Thus, after the pre-support phase of FIG. 2, the device 10 implements the following phases:
a first phase of blood ejection by localized pressure of each protuberance 12 on the area of the foot facing it, illustrated in FIG. 3, then
a second phase of blood ejection after deformation of the protuberances 12 under the effect of the pressure exerted by the foot, illustrated in FIG. 4.

During the second phase, the protuberances 12 flatten and spread out, filling all or part of the space between each of them. This spreading significantly increases the surface area of the device 10 in contact with the foot, such that the compressed protuberances together form an increased surface that exerts a venous return pressure on areas of the foot not solicited during the first phase of blood ejection, as shown by arrows.

Thanks to the device 10, each portion of the surface of the plantar sole 51 is compressed during the second phase, to eject the blood residing there. Such a massage effect cannot be obtained with protuberances that bend under the effect of pressure and cause a massage effect unrelated to the one described here, with moreover an unpleasant floating effect under the foot. Indeed, conventional bending protuberances generate a localized static pressure which lacks a deformation to expel the blood located between such protuberances. The massage action performed by each protuberance 12 in relation to the area of the foot facing it, can therefore be analyzed as the combination of a localized pressure followed by a movement. Such movement helps to better “expel” blood from soft tissues and veins, and significantly improves the effectiveness of the plantar pump massage compared to known massage devices.

Various parameters that can be considered by the person skilled in the art for the implementation of the device 10 will now be discussed, notably the flexibility of the material forming the protuberances, the compressibility of the material forming the protuberances, the nature of the material forming the protuberances, the shape of the protuberances, the arrangement and spacing between the protuberances, and the height of the protuberances.

To obtain the deep massage effect just described, the material forming the layer 11 should be neither too hard nor too soft. A soft material would crush too quickly and would not penetrate into the soft tissues 52 of the plantar sole. Conversely, a material that is too hard would easily penetrate into the soft tissues 52 but would not spread out to form the increased surface mentioned above, which exerts a venous return pressure on areas of the foot not solicited during the first phase of blood ejection. Thus, a soft material but having a hardness greater than that of the soft tissues will preferably be selected. According to tests and calculations performed by the applicant, a material with a Shore A hardness comprised between 5 and 60, preferably between 5 and 40, measured in accordance with ISO 48-4, allows an effective deformation to be applied to the plantar sole during the first phase of blood ejection, while being capable of spreading out during the second phase of blood ejection.

Furthermore, to obtain the increased surface mentioned above, which exerts a venous return pressure on areas of the foot not solicited during the first phase of blood ejection, the material forming the layer 11 should not be too compressible, otherwise the protuberances 12 would not spread out to fill all or part of the space between each of them. Thus, ideally, for maximum spreading, the material forming the layer should be perfectly incompressible, and therefore have a Poisson's coefficient equal to 0.5. Such a material does not exist in practice, although some ideally isotropic polymers approach this value. According to tests and calculations performed by the applicant, a material with a Poisson's coefficient greater than 0.30 (i.e., a compression rate of less than 50%) allows the device to be implemented in conjunction with a judicious choice of the shape of the protuberances. For example, if the Poisson's coefficient of the material used is closer to 0.3 than to 0.5, it may be advantageous to give the protuberances a shape that allows them to occupy the largest possible volume for a given height h and a given width l of their base, in order to account for their partial compressibility.

Many different materials are likely to meet the implementation requirements of the device 10 in terms of flexibility and low compressibility. In an embodiment, the layer 11 is realized with an elastomer material. More generally, and according to studies carried out by the applicant, a material selected from the following list of materials may be used:
Styrene Ethylene Butylene Styrene, or “SEBS”
a silicone gel, notably PolyDimethylSiloxane or “PDMS”,
a Polyurethane foam or “PU”,
an Ethylene-Vinyl Acetate foam or “EVA”,
Ethylene-Propylene-Diene Monomer rubber known as “EPDM”,
Polyvinyl chloride.

To obtain the desired massage effect, the flattening and spreading of the protuberances should fill all or part of the space between each of them, to obtain the increased surface that exerts a venous return pressure on areas of the foot not solicited during the first phase of blood ejection. Thus, in addition to providing a material that is not too compressible, too large a space should be avoided between each protuberance, otherwise they will not be able to fill the empty volume that separates them. Theoretical calculations or simulation calculations of the occupation of the empty volume in different situations of compression of the protuberances allow the person skilled in the art to determine the optimal spacing between them, depending on:
the shape,
the compressibility and hardness of the material used,
and for a determined compression.

It will be noted here that this shape may vary significantly while respecting the above constraints. Thus, in addition to the hemispherical shape that is easy to produce industrially, the skilled person may select protuberances that are cylindrical, pyramidal, with a round, triangular or square base, half ellipsoid, etc.

In some embodiments, however, a substantially hemispherical protuberance shape may be preferred, which can be defined by a height comprised between 0.25 and 2.5 times the width of the base of the protuberance, i.e., a shape having a rounded top whose ratio between height and width does not exceed the above-mentioned limit of 2.5 so that the protuberance does not buckle (i.e., does not bend) under the pressure exerted by the foot.

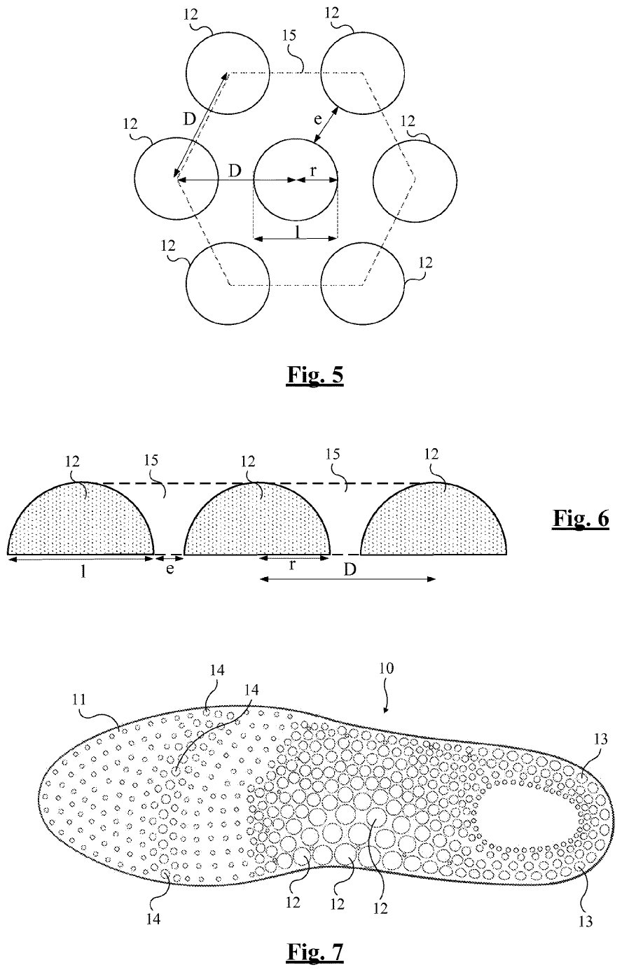

FIGS. 5 and 6 illustrate an exemplary mathematical approach for determining an optimal spacing between equidistant hemispherical protuberances of the same size. In these figures, “D” is the distance between their centers, “e” the distance separating them (edge-to-edge distance), “r” their radius, which is also their height h (not represented), and “I” is the width of their base, which here is twice their radius r. It can be written that:

$$D = {2}^{*} r + e$$

To determine the distance “e”, the assumption is made that the empty volume between the protuberances must be entirely filled when they are partially crushed, and it is assumed that they are constituted of a quasi-incompressible material. According to this hypothesis, a distance “e” is sought such that the volume occupied by the protuberances is equal to the empty volume 15 that separates them. The equality of volumes leads to the following equation:

$$( 6 √ 3 - 4 π ) {r}^{2} + 6 √ 3 er + ( 3 √ 3 / 2 ) {e}^{2} = 0$$

This is recognized as a second-degree equation involving three parameters a, b, c:

$${cr}^{2} + br + a = 0$$

It is deduced:

$$Δ = {b}^{2} - 4 ac$$

$$Δ > 0$$

$$e = ( - b + √ Δ ) / ( 2 a )$$

$$e = 0.19 r$$

$$Or approximately e = 0.2 r$$

This example shows that with a distance equal to 0.2 times their radius, or 0.1 times the width “I” of their base, the protuberances can fill the entirety of the empty volume that separates them when they are subjected to a determined crushing, the effect of which is that the material constituting them is distributed over the entire surface of the layer 11.

According to another approach, a crushing of the protuberances corresponding to a determined reduction in their height is considered, for example a 50% reduction in their height, and a spacing between the protuberances corresponding to a filling rate of less than 100% of the empty volume separating them is sought, when they are crushed with a 50% reduction in their height. Indeed, obtaining the desired massage effect does not necessarily require that there be no empty space left in the increased surface that exerts a venous return pressure on areas of the foot not solicited during the first phase of blood ejection.

Thus, according to an approach recommended by the applicant, the protuberances or a part of them are shaped and arranged so that a 50% reduction in their height causes them to spread out, filling the volume between each of them in a proportion of at least 60%. In a preferred embodiment, the filling of this volume is at least 90% in the arch region, for a 50% reduction in the height of the protuberances.

Calculations conducted according to this approach show that with hemispherical or substantially hemispherical protuberances, the spacing between two protuberances should preferably be comprised between 0.1 and 0.5 times the width of the protuberances or the average value of their respective widths if they are not identical.

As indicated above, the protuberances 12 of the device 10 are intended to be positioned at least under the arch of the foot. In the absence of foot pressure, the protuberances should be in contact with the foot or very close to the foot in order to initiate, from the first foot contact with the ground, the first phase of blood ejection illustrated in FIG. 3. In other words, the tops 121 of the protuberances 12 extending under the arch of the foot, or a majority of them, should be in contact with the foot or very close to the foot. To this end, several embodiments of the device may be envisaged.

In a first embodiment, the layer 11 is assembled on a rigid base of flat shape, non-thermoformable, designed to support at least the heel and the arch of the foot, and optionally the forefoot. In this case, the protuberances have an increasing height as they approach the maximum arch area of the foot, so that the top of each of them is as close as possible to the soft tissues of the arch of the foot.

In a second embodiment, the layer 11 is assembled on a rigid base of flat shape but thermoformable, designed to support at least the heel and the arch of the foot, and optionally the forefoot. In this case, the protuberances may all be of the same height if the rigid base is then thermoformed to adjust to the shape of a user's foot. The top of each protuberance will in this case be very close to the soft tissues of the user's arch of the foot thanks to the shape conferred to the base.

In a third embodiment, the layer 11 is assembled on a rigid or non-rigid base, which has been previously thermoformed to adjust to the shape of a user's foot. It can be an insole that has been manufactured to measure from the imprint of a foot, for example an orthopedic insole realized by a podiatrist, in cork, foam or high-density latex. In this case, the protuberances may, as previously, all be of the same height, unless the doctor wishes to treat a particular area of the arch of the foot.

Various other embodiments can be provided by combination of the aforementioned embodiments. For example, the layer 11 may be associated with a rigid base of anatomical shape, thermoformable or having been thermoformed from a model of typical arch of the foot, without specifically adjusting it to the shape of a determined user's foot (generic anatomical shape). In this case, the protuberances may also have an increasing height as they approach the maximum arch area of the foot, but to a lesser extent than in the first embodiment.

An exemplary embodiment of the device 10 is shown in FIG. 7 in a top view. In this embodiment, the layer 11 is designed to cover the heel and the forefoot in addition to the arch of the foot, i.e., the entire foot with the exception here of a central area of the heel. The layer 11 is here provided with hemispherical protuberances. Thus, the protuberances that appear when viewed from above as having a wider base than the others, are protuberances of greater height.

The layer 11 comprises a first set of protuberances 12 that have an increasing height as they approach the maximum arch area of the foot, and a second set of protuberances 13 that extend over an area corresponding to the perimeter of the heel. The height of the protuberances 13 increases as they approach the periphery of the heel perimeter area, without however reaching the same height as the protuberances 12 located opposite the maximum arch area of the foot. The layer 1 also includes protuberances 14 in a region of the forefoot corresponding to the metatarsophalangeal line, presenting along this line a row of protuberances 14 higher than those of adjacent rows, but lower than the protuberances 12 located opposite the maximum arch area of the foot. Finally, the layer 11 comprises a plurality of other protuberances of lesser height on the rest of its surface, whose “massaging” effect is less than that of the protuberances 12, 13, 14 without, however, being considered as lacking interest.

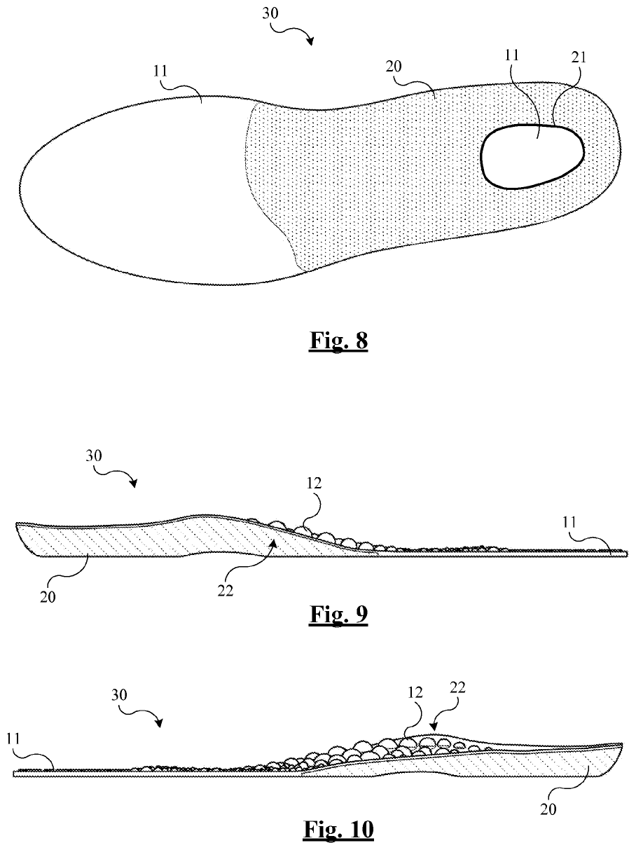

FIGS. 8, 9 and 10 illustrate respectively by a bottom view, a right profile view and a left profile view an exemplary application of the device to the realization of an insole 30. The insole 30 comprises the layer 11 of FIG. 7 assembled on a rigid base 20. The base 20 covers the heel and the arch of the foot without covering the forefoot region. It optionally comprises an orifice 21 in a central region of the heel through which the layer 11 is seen, corresponding to the part of the layer 11 without protuberance (FIG. 13). The rigid base 20 has here an anatomical shape and has been preformed or molded to correspond to a generic foot shape. It thus presents a receiving surface for the layer 11 which is not flat and which notably comprises a raised part 22 in the arch region. Thus here a raising of the layer 11 by means of the base 20 in the arch region is combined with an increase in the height of the protuberances 12 in this same area. In certain embodiments, the shape of base 20 may in addition be adjusted by thermoforming for a perfect adjustment to a user's foot.

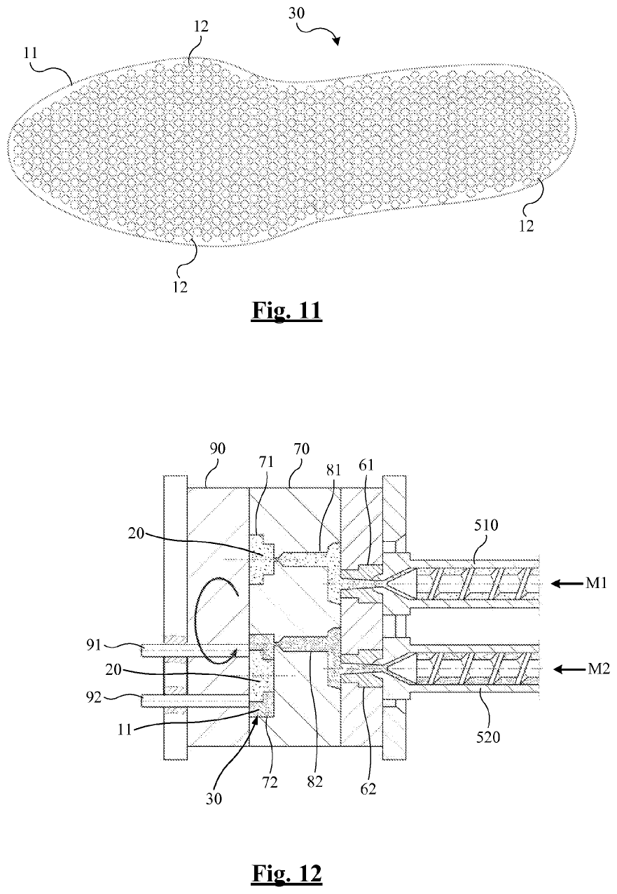

In a variant shown in FIG. 11, the layer 11 only comprises protuberances of the same shape and height 12. The layer 11 is then associated with a rigid base of anatomical shape which preferably presents a stronger arch in the arch region than the base 20 of the insole shown in FIGS. 8 to 10 and which may also, in certain embodiments, be adjusted by thermoforming to the shape of a determined user's foot.

In an advantageous embodiment, the rigid base 20 is thermoformable at a temperature comprised between 60° and 80° C. and is adjusted to the shape of a user's foot according to a simple and inexpensive process. According to this process, an insole 30 of the type shown in FIGS. 8 to 10 is first industrially manufactured, by giving the base 20 a substantially flat shape or an anatomical shape having curvatures corresponding to a generic shape of the foot. If the base has a flat shape or if its generic anatomical shape does not perfectly suit the user, the base 20 is thermoformed by the user himself to finely adjust it to his foot. This step is conducted by the user in the following manner:
the insole 30 is brought to a thermoforming temperature of the base 20, for example by immersing it in boiling water,
the user applies the insole against his foot while it is still hot and is still in a range of thermoforming temperatures of the base 20, for example a temperature comprised between 6° and 80°,
the user then exerts pressure under the base 20, in the arch region, to give it the shape of the arch of his foot. Tests have shown that it was not necessary to protect the user's foot by means of an isothermal sock during the thermoforming phase, if the temperature of the insole is of the order of 75° C. or less. In other embodiments, the base could be thermoformed by means of a heating mold comprising the imprint of the user's foot.

The base 20 may be realized using various materials, some of which can be provided as thermoformable in the temperature range mentioned above. These include notably:
Poly Cyclohexylenedimethylene Terephthalate Glycol or “PCTG”,
Polyethylene Terephthalate Glycol or “PETG”,
Polycaprolactone or “PCL”,
Polylactide type polyester or “PLA”,
Ethylene-vinyl acetate or “EVA”,
Polyurethane or “PU”,
Polyethylene “PE”,
Polypropylene or “PP”, or even
a thermoformable resin.

In an embodiment, the insole 30 shown in FIGS. 8 to 10 or any other variant thereof, is manufactured by means of a two-material injection process in a mold with two impressions. This process allows indifferently the realization of a thermoformable or non-thermoformable base 20 having any desired shape. It is implemented by means of a first material M1 allowing the manufacture of the base 20 and a second material M2 allowing the manufacture of the layer 11. Examples of such materials M1 and M2 have been given above.

A two-material injection machine is shown schematically in cross-section in FIG. 12. The machine comprises a first injection line 510 which is connected upstream to a hopper (not shown) receiving granules of the first material M1. The line 510 comprises heating collars which operate the softening of the material M1, and a rotating screw which pushes the softened material M1 in a pasty state towards a first injector 61. A second injection line 520, of the same structure as the first, is connected upstream to a hopper (not shown) receiving granules of the second material M2, the line 520 bringing the material M2 in a pasty state towards a second injector 62.

The machine also comprises a mold 70 comprising a first impression 71 having the desired shape of the base 20, and a second impression 72 having the desired shape of the layer 11 assembled on the base 20, i.e., the shape of the insole 30 to be manufactured. For reasons of readability of the figure, the two impressions are represented here schematically by arbitrary shapes. The mold 70 also comprises an injection channel 81 of the material M1 into the impression 71, having an inlet connected to an outlet of the injector 61, and an injection channel 82 of the material M2 into the impression 72, having an inlet connected to an outlet of the injector 62.

The machine also comprises a rotating piece 90 equipped with sliding ejection fingers 91, 92. The rotating piece 90 allows the base 20 to be brought into the second impression 72 once it has been realized by injection of material M1 into the first impression 71, so that it can be covered by the material M2. For this purpose, the rotating piece 90 is moved away from the mold 70, in order to extract the base 20 from the first impression 71, then performs a half-turn rotation to bring the base 20 in front of the second impression 72, then is again brought closer to the mold 70 to insert the base 20 into the second impression 72. Although it does not appear in the figure, the rotating piece 90 includes, opposite each impression 71, 72, micro-cavities into which the material M1 penetrates, thus creating micro-links allowing the base 20 to remain attached to the rotating piece 90 during its transport to the impression 72. After injection of the material M2 into the impression 72, the rotating piece 90 is again moved away from the mold 70 and the sliding fingers 91, 92 push the base 20 forward to break the micro-links that hold it to the piece 90 and thus eject the insole 30.

The two materials M1, M2 being injected hot and in the pasty state, chemical bonds are formed between the base 20 and the layer 11 ensuring the cohesion of the whole. It will be noted that the phases of injection of the material M1 and of the material M2 can be concomitant, which allows doubling the production rate, a base 20 being realized by injection while a layer 11 is injected on a previously realized base 20, an insole 30 being ejected from the piece 90 before each of its rotations.

1. A foot massage device, designed to be positioned under all or part of a foot and at least under an arch of the foot, the foot massage device comprising:
a front face designed to be in contact with the foot, the front face of comprising a plurality of non-hollow protuberances configured to come into contact with the arch of the foot to exert pressure capable of improving venous return, each protuberance having a base, a top, a height and a shape determining a volume occupied by the protuberance,
wherein the protuberances are made of a soft incompressible or moderately compressible material having a Poisson's coefficient greater than 0.30, and are shaped and arranged so that a flattening of the protuberances causes them to spread out, filling all or part of the volume between each of them and increasing a surface area of the device in contact with the foot.

2. The device according to claim 1, wherein at least in one region of the device, the protuberances are shaped and arranged so that a 50% reduction in their height causes them to spread out, filling the volume between each of them in a proportion of at least 60%.

3. The device according to claim 1, wherein at least in the arch of the device, the protuberances are shaped and arranged so that a 50% reduction in their height causes them to spread out, filling the volume between each of them in a proportion of at least 90%.

4. The device according to claim 1, wherein the protuberances are made of a material having a Shore A hardness comprised between 5 and 40 measured in accordance with ISO 48-4.

5. The device according to claim 1, wherein the protuberances have an increasing height as they approach a maximum arch area of the foot.

6. The device according to claim 1, wherein the protuberances have, between their base and their top, a constant or variable height comprised between 1.5 mm and 25 mm.

7. The device according to claim 1, designed to also cover a heel and a sole of the foot and comprising protuberances at least in a region of a forefoot of the foot corresponding to a metatarsophalangeal line, and at least around a perimeter of the heel.

8. The device according to claim 1, wherein the protuberances are substantially hemispherical in shape and have a height comprised between 0.25 and 2.5 times a width of their base.

9. The device according to claim 1, wherein at least in the arch of the device, spacing between two protuberances is comprised between 0.1 and 0.5 times a width of the protuberances or an average value of their respective widths if they are not identical.

10. The device according to claim 1, wherein the protuberances are made of an elastomer material.

11. The device according to claim 1, wherein the protuberances are made of a material selected from the group comprising:
Styrene Ethylene Butylene Styrene (SEBS),
a silicone gel, in particular PolyDimethylSiloxane (PDMS),
a Polyurethane foam (PU),
an Ethylene-Vinyl Acetate foam (EVA),
polyvinyl chloride (PVC),
EPDM rubber.

12. The device according to claim 1, comprising a base designed to support at least a heel and the arch of the foot, and a soft layer assembled on the base and in which the protuberances are formed.

13. The device according to claim 12, wherein the base is thermoformable at a temperature comprised between 60° and 80° C.

14. The device according to claim 13, wherein the base is made of a material included in the group comprising:
Poly Cyclohexylenedimethylene Terephthalate Glycol (PCTG),
Polyethylene Terephthalate Glycol (PETG),
Polycaprolactone (PCL),
Polylactide type polyester (PLA),
Ethylene-vinyl acetate (EVA),
Polyurethane (PU),
Polyethylene (PE),
Polypropylene (PP), and
a thermoformable resin.

15. A method of manufacturing and shaping a device according to claim 13, the method comprising:
an initial step of manufacturing the device at an end of which the base has a determined shape, and
a step of thermoforming the base to adapt its arch to the shape of a user's foot, the thermoforming step comprising the steps of:
bringing the device to a thermoforming temperature,
applying the device against the foot while the device is still hot and is still in a range of thermoforming temperatures, and
exerting pressure under the device, in the arch, to thermoform the device to the shape of the arch of the foot.

16. A method of manufacturing a device according to claim 1, by two-material injection in a mold comprising a first impression designed to receive by injection a material forming a base of the device, and a second impression receiving after injection of the base, a material forming a soft layer.

17. A method of foot massage for non-therapeutic purposes, using a device designed to be positioned under all or part of a foot and at least under an arch of the foot, the device comprising a front face designed to be in contact with the foot, the method comprising:
providing, on the front face of the device, a plurality of non-hollow protuberances configured to come into contact with the arch of the foot to exert pressure capable of improving venous return, each protuberance having a base, a top, a height and a shape determining a volume occupied by the protuberance, the protuberances being made of a soft incompressible or moderately compressible material having a Poisson's coefficient greater than 0.30, and being shaped and arranged so that their flattening causes them to spread out, filling all or part of the volume between each of them and increasing a surface area of the device in contact with the foot,
wherein the front face is configured to:
provide a first phase of blood ejection by localized pressure of each protuberance on an area of the foot facing it, and
provide a second phase of blood ejection after deformation of the protuberances under the effect of the pressure exerted by the foot,
the compressed protuberances together forming an increased surface that exerts a venous return pressure on areas of the foot not solicited during the first phase of blood ejection.

18. The method according to claim 17, comprising providing, at least in one region of the device, protuberances shaped and arranged so that a 50% reduction in their height causes them to spread out, filling the volume between each of them in a proportion of at least 60%.

19. The method according to claim 17, comprising providing at least in the arch of the device, protuberances shaped and arranged so that a 50% reduction in their height causes them to spread out, filling the volume between each of them in a proportion of at least 90%.

20. The method according to claim 17, wherein the protuberances are made of a material having a Shore A hardness comprised between 5 and 40 measured in accordance with ISO 48-4.

21. The method according to claim 17, wherein the protuberances are given an increasing height as they approach a maximum arch area of the foot.

22. The method according to claim 17, wherein the protuberances are given, between their base and their top, a constant or variable height comprised between 1.5 mm and 25 mm.

23. The method according to claim 17, wherein the device is designed to also cover a heel and a sole of the foot, the method also comprising providing protuberances at least in a region of a forefoot of the foot corresponding to a metatarsophalangeal line, and at least around a perimeter of the heel.

24. The method according to claim 17, wherein the protuberances are given a substantially hemispherical shape and a height comprised between 0.25 and 2.5 times a width of their base.

25. The method according to claim 17, wherein, between two protuberances, at least in the arch of the device, a spacing is provided comprised between 0.1 and 0.5 times a width of the protuberances or an average value of their respective widths if they are not identical.

26. The method according to claim 17, wherein the protuberances are realized in an elastomer material.
